(19) United States
(12) Patent Application Publication
(10) Pub. No.: US 2009/0254573 A1
(43) Pub. Date: Oct. 8, 2009

(54) Plant floor event protocol and schema

(75) Inventors: Steven Wojciechowski, Waterford, MI (US); Leandro G. Barajas, Troy, MI (US); Michael D. Carpenter, Rochester Hills, MI (US); Phillip A. Dufrin, Williamston, MI (US)

Correspondence Address: Quinn Law Group, PLLC, 39555 Orchard Hill Place, Suite 520, Novi, MI, 48375, US

(73) Assignees: GENERAL MOTORS CORPORATION, Detroit, MI (US); GM GLOBAL TECHNOLOGY OPERATIONS, INC., Detroit, MI (US)

(21) Appl. No.: 12/062,572

(22) Filed: Apr. 4, 2008

(51) Int. Cl. G06F 17/30

(52) U.S. Cl. 707/100; 707/E17.005

(57) ABSTRACT

A method is provided for managing information on a plant floor, and includes recording a definition file, such as an extended markup language (XML) schema, in a source device, and generating a plant floor event (PFE) message as a bit array or string array. The PFE message transfers from the source device to a host device or other appliance. The method then includes executing at least one action in response to the PFE message. A system is also provided for managing information on a plant floor, and includes a PLC that generates a PFE message as a bit or string array. The system includes an alarm database, and automatically propagates the PFE message upward from the PLC to a host device, such as a server, a database, or a display device, and automatically executes an action in response to the PFE message.

### TECHNICAL FIELD

The invention relates to a method and a system for managing various disparate process data and/or other information generated within a plant environment using a shared communications protocol and schema.

### BACKGROUND OF THE INVENTION

Plant floor systems typically utilize a myriad of information collection and reporting systems in order to monitor the vast number of often disparate processes conducted within a plant. Such plant floor systems, also commonly referred to as plant information systems, may include families of different information systems which may not communicate with each another in a useful manner. For example, a manufacturing plant may employ a maintenance system specifically dedicated to monitoring the operational status of a particular piece of machinery, and an altogether different tooling system for monitoring whether an otherwise operational machine is currently unavailable, as it awaits the arrival of a new tool, fluid or filter replacement, or other such routine service. Likewise, other plant floor systems may monitor changing process block/starve conditions, production throughput or over-cycling conditions, product quality, error proofing, production routing, option data delivery, and/or various other process conditions and control variables.

Each plant floor system can consist of various interconnected computer hardware and/or software devices that provide a plant-wide information collection and reporting system for a particular purpose, as described above. Hardware devices may include one or more programmable logic controllers (PLC) of the type known in the art, host devices, machines, servers, information databases, and/or data acquisition systems. PLC can each include a central processing unit or CPU, memory, and numerous simulated input and output relays, counters, processors, timers, etc., which may be configured to control a particular process with a great deal of precision. Typically, the individual processes have a dedicated PLC for running or controlling that particular process. A single human-machine interface (HMI) or a computer interface may be interconnected with multiple PLC in order to facilitate programming of the various PLC, and/or to facilitate review of any information related to the controlled process, or to provide other such functionality.

Plant floor systems using PLC devices may require a polled “bit banging” data transfer, as that term will be understood by those of ordinary skill in the art, wherein bits of data describing a measured value are transmitted to a host system according to a preset time interval, or an unsolicited bit banging data transfer, wherein the bits are transmitted when there is a change in the information represented by the bit package. While conventional bit banging may enable some degree of information data transfer within a plant floor system, such systems may be less than optimal due to the extensive time and expertise required for the initial programming and subsequent reprogramming. That is, each data bit must correspond to a particular piece of information that must then be mapped on a particular PLC device, mapped again on a host system, and mapped once again within an information database. More modern systems may utilize known ASCII echoing techniques to improve upon certain bit banging limitations, and thus reduce the amount of mapping required, however such systems remain less than optimal for certain purposes.

### SUMMARY OF THE INVENTION

Accordingly, a method and system are provided for managing information on a plant floor. Using the method and system of the invention, a plant floor event (PFE) message can be generated as an encoded bit array or string array, as defined by a recorded definition file. The definition file can be an extended markup language (XML) schema or other definition file, with the PFE message being automatically pushed or propagated upward from a particular process or line, i.e., from a particular source device, to a host device, such as a server, database, appliance, display device, and/or another process devices as desired.

In particular, the method includes recording a definition file, referred to hereinafter as a schema, in a first memory location of the source device. A PFE event message, which is a set of information corresponding to either an internal program variable or an external input variable, is an encoded string array, a bit array, or other suitable array, as defined by the schema. The PFE message is automatically transferred via a predetermined communications protocol from the first memory location to a second memory location of the host device, and then stored in the second memory device. At least one action is then executed in response to the PFE message.

According to the method, executing an action can include transmitting a second PFE message from the host device to the source device, such as a PLC, as well as activating an alarm. The first or second PFE messages can be, but are not limited to, a production count, an alarm status, a process status, a progress indicator, a device configuration status, and a reconfiguration command.

In one embodiment, the method determines if the schema is a known schema stored within the host device, and if not, the method automatically records the schema within the host device among the known schema. In this manner, schema can be automatically updated and propagated throughout the various computing devices used on the plant floor, without having to hardcode any of the devices.

The PFE message includes an event type, which can be an electronic handshake, a heartbeat, an IP address, a reset event, a time synchronization event, a resource event, an alarm event, a counter event, a schema event, and an ad-hoc event.

An information management system is also provided for managing information on a plant floor, with the system including a programmable logic controller (PLC) having a definition file for defining a PFE message, with the PLC generating the PFE message in response to an internal process variable or to an external input. The system has at least one alarm database in electrical communication with the PLC, and that is operable for storing different alarm codes. The system also includes a host system or other appliance that is in electrical communication with the PLC. The system is self-configurable, as it is operable for automatically propagating the PFE message from the PLC to the host device, and is self-defining by automatically propagating a change in the definition file to the host device. The system executes at least one action in response to the PFE message, such as transmitting a second PFE message from the host device to the source device, or activating an alarm.

The above features and advantages and other features and advantages of the present invention are readily apparent from the following detailed description of the best modes for carrying out the invention when taken in connection with the accompanying drawings.

### BRIEF DESCRIPTION OF THE DRAWINGS

FIG. 1 is a schematic illustration of a plant floor event (PFE) system according to the invention;

FIG. 2 is a schematic illustration of a programmable logic controller or PLC of FIG. 1;

FIG. 3 is a graphical table describing various exemplary plant floor events (PFE) that are usable with the PFE method and system of the invention as respectively shown in FIGS. 1 and 5;

FIG. 4 is a graphical table describing a representative array usable with the PFE system and method of the invention as respectively shown in FIGS. 1 and 5;

FIG. 5 is a flow chart describing a PFE-driven method using the PFE system of FIG. 1;

FIG. 6 is a graphical representation of an exemplary communications protocol for a pair of PFE;

FIG. 7 is another graphical representation of an exemplary communications protocol for a third PFE;

FIG. 8 is another graphical representation of an exemplary communications protocol for a fourth PFE; and

FIG. 9 is a graphical representation of an exemplary communications protocol for a fifth PFE.

### DESCRIPTION OF THE PREFERRED EMBODIMENTS

Referring to the drawings, wherein like reference numbers correspond to like or similar components throughout the several figures, and beginning with FIG. 1, an information management system 10 is provided for commonly managing information related to the various similar as well as disparate processes conducted on a plant floor, regardless of the number or variety of different or disparate plant floor systems that may be used. The term “information” as used herein is a quality of a message transmitted or sent from a sender to one or more receivers, such as from a source device or first computing device to a host or a second computing device, and vice versa. Information is embodied as a message describing or containing the information to be communicated to and understood by the recipient. The message providing the information can be, for example, a measured or sensed process or environmental parameter, the occurrence or nonoccurrence of a process event, a counter value, a status check, a communications check, a time synchronization message, and/or any other data that is relevant to the process being reported or described.

In FIG. 1, and within the scope of the invention, such information is represented generally as the arrow “PFE”, which as described above refers to “Plant Floor Event” message. The system 10 includes one or more computing devices, such as a programmable logic controller or PLC 14. As will be understood by those of ordinary skill in the art, a PLC 14 as used herein can be any process control or computing device having a microprocessor or central processing unit (CPU), various electronic and/or magnetic memory locations or areas 17, and any appropriate control circuits and/or virtual relays necessary for executing the predetermined sequences or ladder logic in order to produce a desired output response based on one or more input control variables. Using one or more PLC 14, therefore, one may control an associated process, such as the representative plant floor process 12 shown in FIG. 1.

The PLC 14 is in direct or wireless communication with the process 12 via one or more transducers or others sensors 13, with the process 12 also abbreviated as “P” and the sensor 13 also abbreviated as “S” in FIG. 1 for clarity. The PLC 14 includes an alarm database or active alarm list (AAL) 27, which can be configured as a single or common alarm database of all PFE messages used or transmitted within the system 10. As indicated by the dotted line 31, the PLC 14, sensor 13, and AAL 27 can be configured as a single device, or separately as shown. The PLC 14 further includes one or more human-machine interface (HMI) devices 22. The HMI device can be any user input device offering access to the PLC 14, such as a keyboard, a personal digital assistant (PDA), a touch screen, a Turing machine, and/or any other suitable device providing a user interface to the PLC 14. While shown as a separate device in FIG. 1, those of ordinary skill in the art will understand that the HMI device 22 and the PLC 14 may be configured or integrated as a single unit. Likewise, each HMI device 22 may be connected to more than one PLC 14, while a single PLC 14 is generally used or associated with a particular plant floor process, such as the process 12 shown in FIG. 1.

The PLC 14 is in communication with a host device or host 16, and with a main or central database (DB) 18 having a global alarm database 19, either directly or through the host 16. The host 16 is any computer hardware and software device configured for collecting, gathering, and/or generating the information necessary for describing the process 12. Such information may be gathered in real time or by data sampling via known analog and/or digital measurement methods, such as analog or digital data or status detection using the sensor or sensors 13. The PLC 14 is also in communication with one or more drivers (D) 25, and/or with one or more marquees (M) 20 or other suitable display devices, as will be described below.

In addition to information collection, data acquisition or information encoding can include digitizing any collected information for storage in the database 18, automatically or manually analyzing the information, and/or presenting the information on a display device, such as a centralized process control and display software package hosted or resident within the host 16. Data acquisition or information gathering may include, by way of example, the measuring of a temperature of a room in which the process 12 resides, a fluctuating pressure inside of a process chamber (not shown), and/or a force applied to an object during the process 12, or determining a machinery maintenance status, a line status, and/or any other relevant process control and environmental information that might be desirable to collect, report, and/or retain.

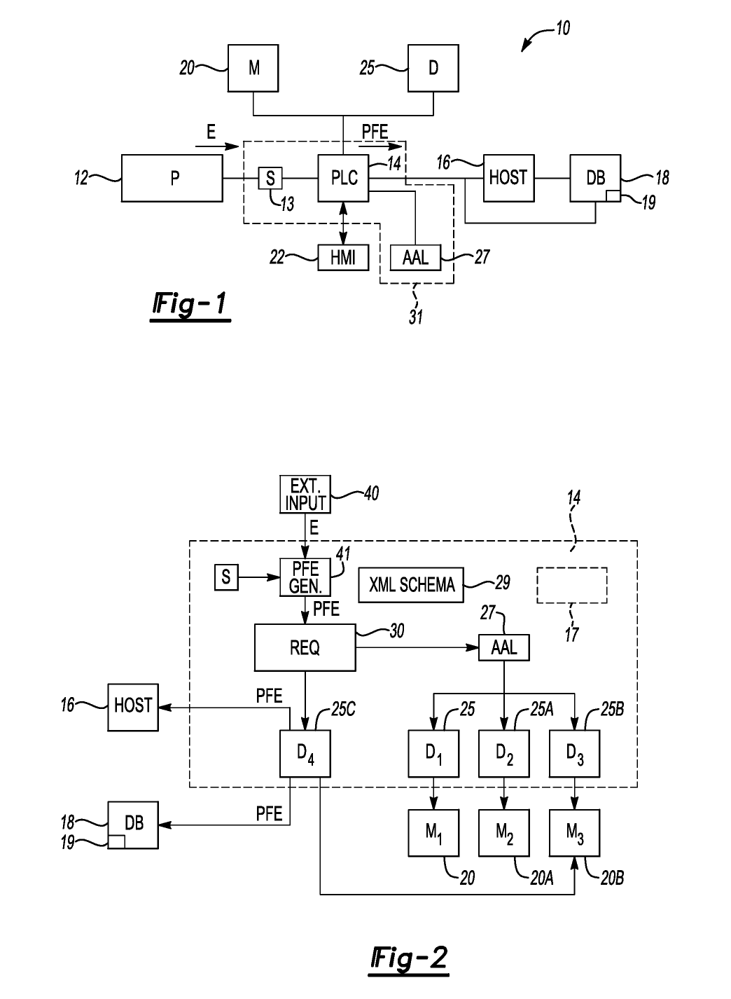

Referring to FIG. 2, the PLC 14 of FIG. 1 is shown in further detail. The PLC 14 is populated or programmed with a definition language or schema, which in one embodiment is the known general purpose Extensible Markup Language or XML schema 29, which is then replicated or copied into in each PLC 14 that is used on the plant floor. As will be understood by those of ordinary skill in the art, a definition file/schema is a built-in data type that constrains any text used for communicating within the system 10 (see FIG. 1), and that resides as a data tag or a memory location within each PLC 14. A definition file/schema defines the legal building blocks of a resultant document, such as the type definitions and array definitions of an array 60 as shown in FIG. 4 and described below.

In particular, the XML schema 29 may be developed using the OPC™ Foundation Complex Data Specification Version 1.0 or another suitable industry-standard or public domain data specification, and defines the various elements and/or attributes that are allowed to appear in the resultant document, the order and/or number of the elements usable in the document, and whether a particular element is empty or can include text. A definition file/schema such as the XML schema 29 also defines the data types that are available for the different elements and attributes, any default and fixed values for the elements and attributes, and other such information.

Information comprising the PFE message (arrow PFE) is sensed, measured, or otherwise detected by the sensor “S” or multiple such sensors, and then generated either within the PLC 14, as represented by the box “PFE GEN” 41, or alternately or concurrently entered into the PLC 14 from an external input 40, with the PFE message then fed into a raw event queue or REQ 30 resident within the PLC 14. The REQ 30 may be an adjustable circular or linear buffer of a fixed size, holding for example a five hundred PFE messages or any another desirable number, with the oldest PFE message resident within the buffer being discarded upon recording of the newest or most recently generated PFE message.

Any active or current alarms within the REQ 30 are then provided to the active alarm list or AAL 27, which as described above is a single alarm database of all PFE messages, and which is common to all PLC 14 used with the system 10 of FIG. 1. The active alarms described by the AAL 27 may be relayed to one or more unique control programs or drivers 25, 25A, and 25B (abbreviated D1, D2, and D3, respectively), and/or to one or more display devices or marquees 20, 20A, and 20B (abbreviated M1, M2, and M3, respectively), as needed, depending on the particular alarm. For example, the driver 25 (D₁) may be an alarm banner driver for localized use with a particular display 20 (M₁) of an HMI device 22 (see FIG. 1), the driver 25A (D₂) may be an RS-232 driver for generating a simple ASCII display 20A (M₂), and the driver 25B (D₃) may be a marquee driver for driving a marquee 20B (M₃). Likewise, the REQ 30 may feed another driver 25C (D₄), such as an event client driver, which in turn may activate one of the displays, such as the display 20B (M₃).

Still referring to FIG. 2, the driver 25C is in communication with both the host 16 and the database 18, and therefore the REQ 30 residing within the PLC 14 is pushed upward to the host 16 and the database 18, thus allowing the PLC 14 to become a single point of configuration for the system 10 shown in FIG. 1. Since there is also no hard-coding of the database 18, any changes or updates made on the plant floor, such as any new PFE types that might be created on a particular PLC 14, immediately propagate or “map” all the way up from the PLC 14 to the host 16 and the database 18. Likewise, it is possible to assign available resources within the system 10 (see FIG. 1) from a given PLC 14 via the HMI device 22, rather than from the host 16 in the conventional manner. Finally, a server registration list (not shown) and a server structure (not shown) may also be provided within the PLC 14 when multiple servers are used, with the server registration list identifying the particular PLC 14 by the type of information it is expected to provide, and identifying which of the multiple servers are to be communicated with by the PLC 14.

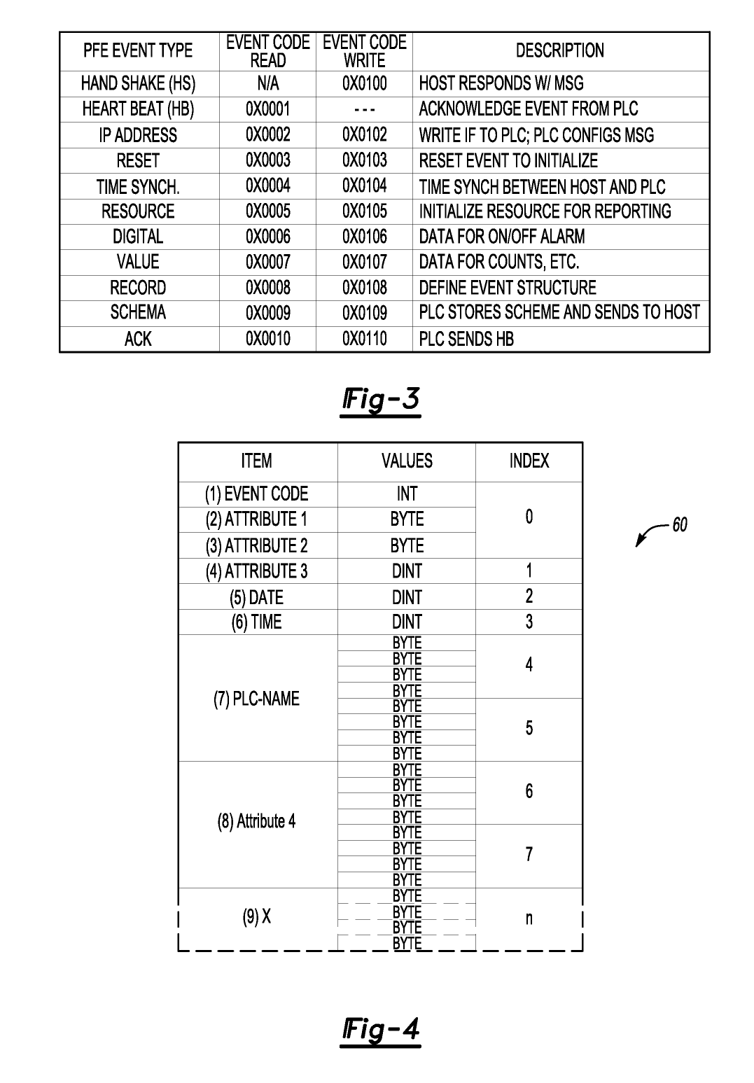

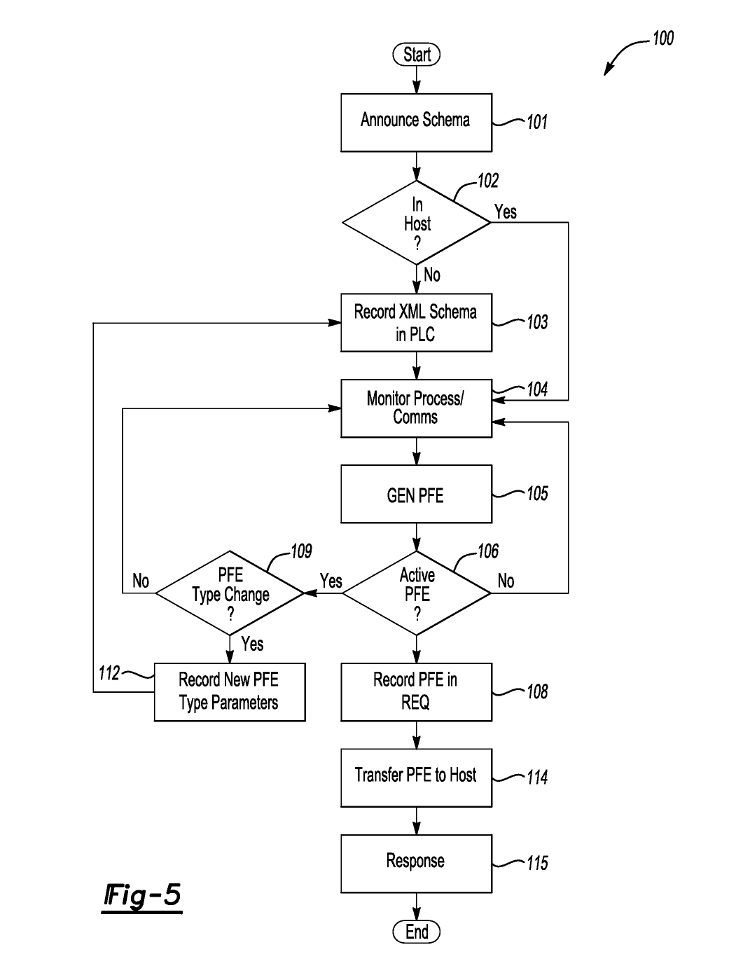

Referring to FIG. 3, an exemplary list of plant floor event (PFE) messages is provided, with each being usable with the system 10 of FIG. 1 and with the method 100 of FIG. 5 described later hereinbelow. Each PFE event type is assigned a unique event code. In one embodiment the PFE event types may include, without being limited to, the following:

Electronic Handshake (HS): a confirming signal or message that a prior signal or message has been received by an intended machine, process, or other appliance. In this PFE, the host 16 (see FIGS. 1 and 2) responds with a suitable message;

Electronic Heartbeat (HB): a signal generated by an internal timer that runs automatically and announces if a message is not received upon the passage of a predetermined amount of time, such as every 60 seconds. Again, the host 16 responds with an acknowledgement;

IP Address: new or changed IP address of a particular appliance, which may then be written to the PLC 14 so that the PLC 14 may configure itself to send PFE to the new appliance, or a time synchronization signal between the PLC 14 and a particular appliance, often used to ensure all appliances used on the plant floor are keeping the same time. If the IP address is transmitted to the PLC 14, such as when the PLC 14 originally requests confirmation of its own IP address, the IP address is written to the PLC 14. If the PLC 14 is responding to a request from the host 16A, the PLC 14 may configure a suitable message and transmit this back to the host 16;

Reset PFE: can be used to command a particular PLC 14 or related process 12 (see FIG. 1) to reset or initialize itself;

Time Synchronization: this PFE can be used to synchronize the time of the PLC 14 and the host 16;

Resource PFE: can be used to describe the initialization of a particular area or subarea for displaying and reporting;

Digital Event: such as a new digital alarm can transmit information regarding whether a particular alarm is on or off;

Value: this PFE can describe information or data for production counts, buffer counts, etc;

Record PFE: can be used to define an event structure for a particular PFE;

Schema: this PFE can be generated and stored in the PLC 14, such as when a new schema is created on the PLC 14, and then transmitted to the host 16 for recording therein;

Acknowledgment: can be used by the PLC 14 to send a heartbeat (HB) to the host 16 as needed, in response to another PFE.

Other PFE may be envisioned within the scope of the invention, with the exemplary list shown in FIG. 3 and described above discussing only some of the possible PFE usable within the scope of the invention. Also, it should be understood that each of the PFE in FIG. 3 can be used singly or in combination with other PFE. For example, a particular exchange of information between a PLC 14 and a host 16 may involve sending a request for an IP address, a handshake (HB) in response to receiving the request from the host 16, and a transmitted IP address to the host 16, followed by another handshake (HS).

Referring to FIG. 4, the information embodied by the PFE message may be encoded as or represented by an array 60, which can be transmitted or relayed as needed within the system 10 (see FIG. 1) whenever a change or update is made, such as the creation of a new PFE message, a new alarm, etc. As with FIG. 3, FIG. 4 is exemplary, and those of ordinary skill in the art will understand that other array types, such as bit or string arrays, may be used to fully describe a particular PFE message, depending on the structure of the XML schema 29 (see FIG. 2) programmed into or recorded in the PLC 14 (see FIGS. 1 and 2). A position or index may be assigned to each data item describing the PFE message, with each data item having a predefined value that is determined by the XML schema 29 (see FIG. 2).

For example, an index of 0 may correspond to an “event code”, and other attributes thereof may be represented as a single byte of data, or multiple bytes and/or integer values. One or more additional attributes may be assigned to an index of 1. An index of 2 and 3 may respectively correspond to the date and time of the PFE message, while indexes of 4 and 5 can describe the particular PLC 14 (see FIGS. 1 and 2) by “PLC name”. Other indexes such as 6 and 7 can more uniquely identify desired aspects of the information encoded in the bit array 60 and transmitted within the system 10 (see FIG. 1), thus helping to ensure that data is not inadvertently lost or misdirected within the system 10, or that the PFE message itself is fully descriptive of the event it intends to describe. If additional information is required in the bit array 60, another index 9 may be added as needed, as represented by the dotted lines.

Referring to FIG. 5, a method 100 for managing information on a plant floor begins with step 101, where a definition file, such as the XML schema 29 (see FIG. 2) described above, is announced from one appliance or a source device, such as from a PLC 14, to another appliance such as the host 16. The method 100 then proceeds to step 102.

At step 102, the method 100 includes determining if the schema recorded at step 101 is a known schema, i.e., whether the schema is presently resident or previously recorded within the host 16 (see FIGS. 1 and 2). If so, the method 100 proceeds to step 104, otherwise the method 100 proceeds to step 103.

At step 103, the schema announced at step 101 is recorded or stored within a memory location 17 of a source device, such as the PLC 14 (see FIGS. 1 and 2). Once the definition file/schema is properly recorded on a single PLC 14, it can then be replicated on each PLC 14 used on the plant floor used with the system 10 of FIG. 1, when multiple PLC 14 are used to support the system 10 (see FIGS. 1 and 2). The method 100 then proceeds to step 104.

At step 104, the process 12 (see FIG. 1) and/or communications between interconnected appliances, such as a PLC 14 and host 16 (see FIGS. 1 and 2), is actively and/or passively monitored, which may include sensing numerous dynamic variables describing the process 12, in order to detect or otherwise determine the presence of a generated PFE message (see step 105). The method 100 then proceeds to step 105.

At step 105, a PFE message is generated, either automatically by an appliance, due for example to a sensed variable or value, or externally by a user, for example an operator hitting a “stop” or a kill switch. The generated PFE message is an encoded message, such as an array 60 of FIG. 4 discussed above. The encoded PFE message is defined by and thus corresponds to the definition file/schema recorded in the PLC 14 (see FIGS. 1 and 2), such as the XML schema 29 (see FIG. 2) described above. The method 100 then proceeds to step 106.

At step 106, the method 100 then includes determining whether the generated PFE message (see step 105) is an active PFE message, i.e., a PFE message requiring some action, or whether it is a previous PFE message that does not require any present response. If the latter, the method 100 repeats steps 104 and 105. Otherwise, the method 100 proceeds to step 109.

At step 108, the PFE message is recorded in the raw event queue (REQ) 30 (see FIG. 2), which is a memory location that is different from the memory location 17 of the PLC 14 (see FIGS. 1 and 2). The REQ 30 may be a buffer of a fixed size, such as 500 events, with the oldest PFE message in the queue being discarded upon recording of the newest PFE message. After recording the PFE message in the REQ 30, the method 100 proceeds to step 114.

At step 109, the PLC 14 (see FIGS. 1 and 2) determines if the PFE message detected at step 106 is a PFE event type change (see FIG. 3). If so, the method 100 proceeds to step 112, otherwise the method 100 repeats step 104.

At step 112, the new event type parameters are recorded within the host 16 and/or the PLC 14, and the method 100 returns to step 103. As described above, the newly recorded PFE event type is automatically replicated or “mapped” upward to the host 16 and to the database 18 (see FIGS. 1 and 2), and thus is immediately made available plant-wide.

At step 114, the PFE message generated at step 105 is transferred to an appliance as described above, such as the host 16 (see FIG. 1), although the term “appliance” also can refer to other devices as the main database 18, any displays 20, 20A, and/or 20B (see FIG. 2), another PLC 14, and/or any servers (not shown) used within the system 10 (see FIG. 1). The method 100 then proceeds to step 115.

At step 115, a predetermined action or response is executed. A response as used herein can be the generation of another PFE message by the host 16 (see FIG. 2), which is transmitted back to the source device or PLC 14 9 see FIG. 1). The response can also be the activation of an audible alarm and/or activation of a visual display or message, such as an ASCII display, a “bingo board”, or a marquee display. As the response of step 115 can be another PFE message, the protocol governing this exchange of information between a source device and a host will now be explained.

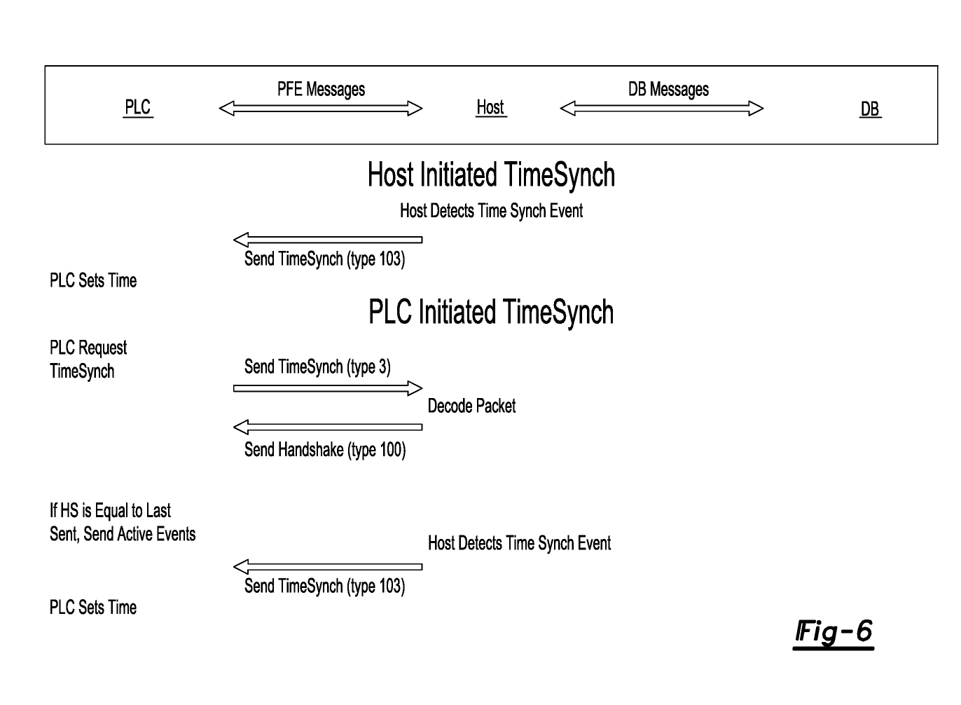

Referring FIG. 6, a time synchronization PFE is initiated by the host 16 (see FIGS. 1 and 2), with the host 16 sending a time synchronization PFE message to the PLC 14 (see FIGS. 1 and 2). In response, the PLC 14 synchronizes its internal clock to conform to the time encoded in the message from the host 16. FIG. 6 also describes the communications protocol of a PLC-initiated time synchronization, wherein the PLC 14 sends a time synchronization request to the host 16. The host 16 receives the message, decodes the packet, and responds via an electronic handshake (HS) as described previously hereinabove. The PLC 14 receives the electronic handshake, and if the handshake is equal to or corresponds to the last PFE message sent, that is, is a response to the PLC-initiated time synch and not a separate PFE message, the host 16 then sends the requested time synch information, and in response, the PLC 14 sets its clock or internal time accordingly.

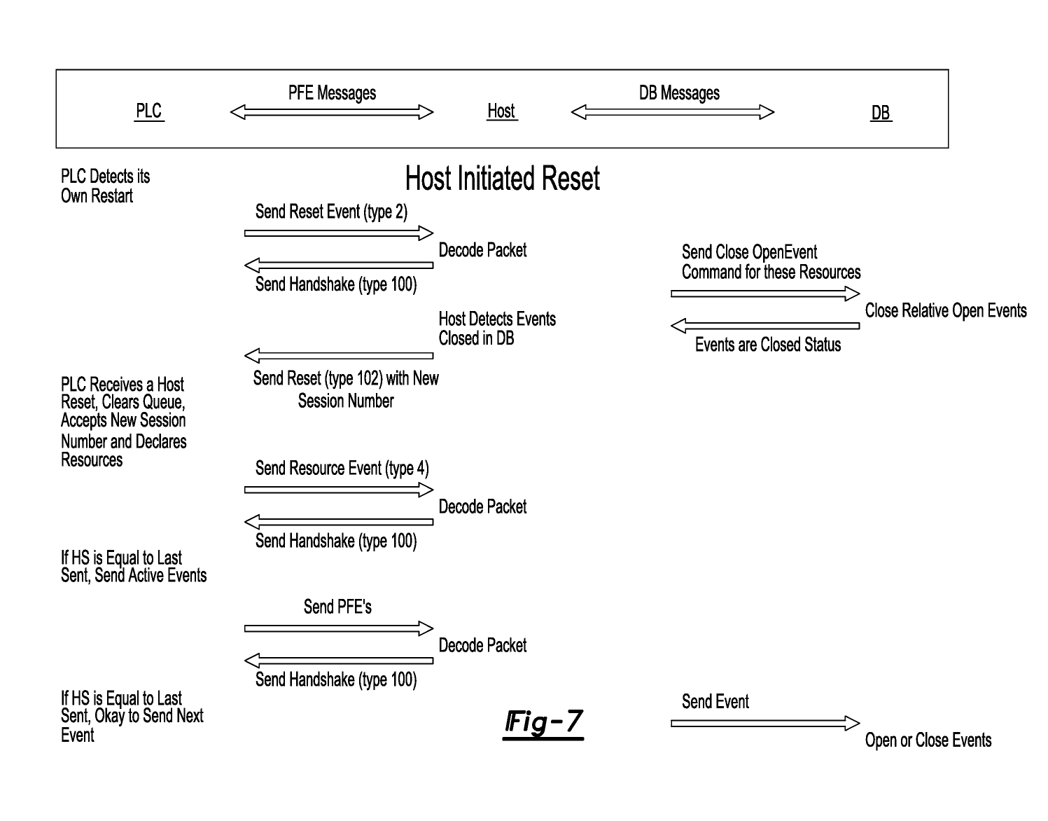

Referring to FIG. 7, another representative PFE message is the reset PFE message described above. In this PFE message, the PLC 14 detects its own restart, and then sends a PFE message containing a reset event (see FIG. 3) to the host 16. As before, the host 16 decodes the packet, and then sends an electronic handshake (HS) back to the PLC 14. The host 16 also sends a command to the main database to close any open events for the associated resources. When the host 16 has determined that the active events for the subject PLC 14 have been closed in the main database, the host 16 sends a reset message to the PLC 14 containing a new session number. The PLC 14 receives the new session number, clears its event queue, and declares its resources by transmitting another message containing the resource event to the host 16. Again, the host 16 decodes the packet, i.e., the PFE message, and responds by sending another electronic handshake (HS) to the PLC 14. As before, the PLC 14 responds by sending its active events to the host 16, where the appropriate action, if any, is taken.

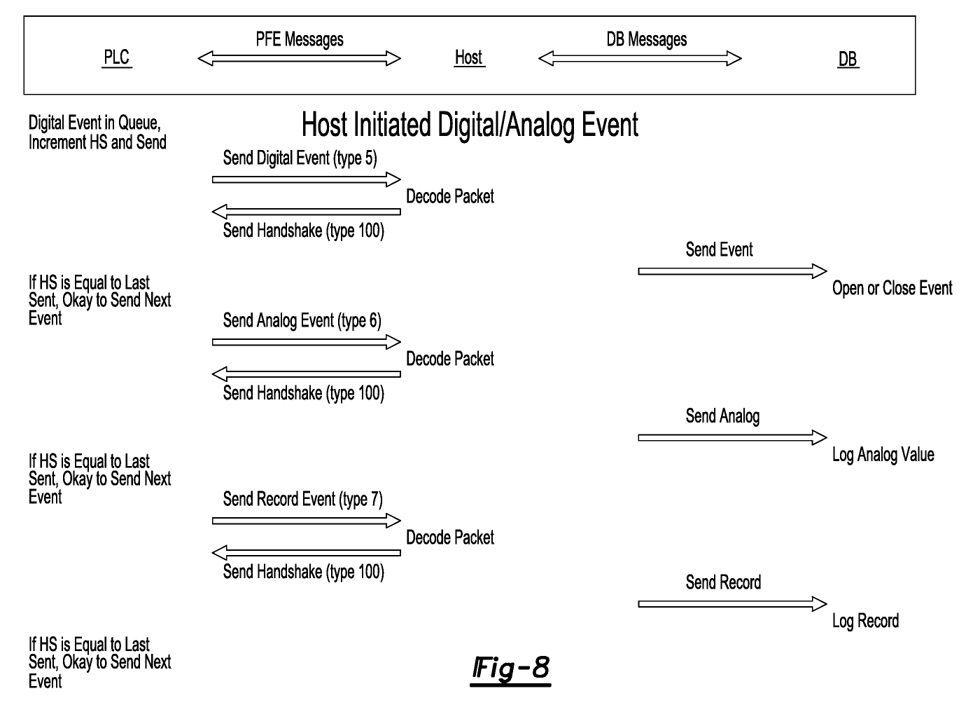

Referring to FIG. 8, the protocol associated with a representative host-initiated digital or analog event is shown, wherein a digital event described above is created in the REQ 30 (see FIG. 2), and the PFE message is sent to the host 16, where the packet is decoded as before, and an electronic handshake (HS) is sent to the PLC 14. The host 16 then relays the PFE message to the main database 18 (see FIGS. 1 and 2), where the event is either open or closed as needed. In the same manner, subsequent events, shown in FIG. 8 as an analog event and a record event as described above, are transmitted to the host 16, and appropriate action is taken, such as writing the value of the event or alarm to a log.

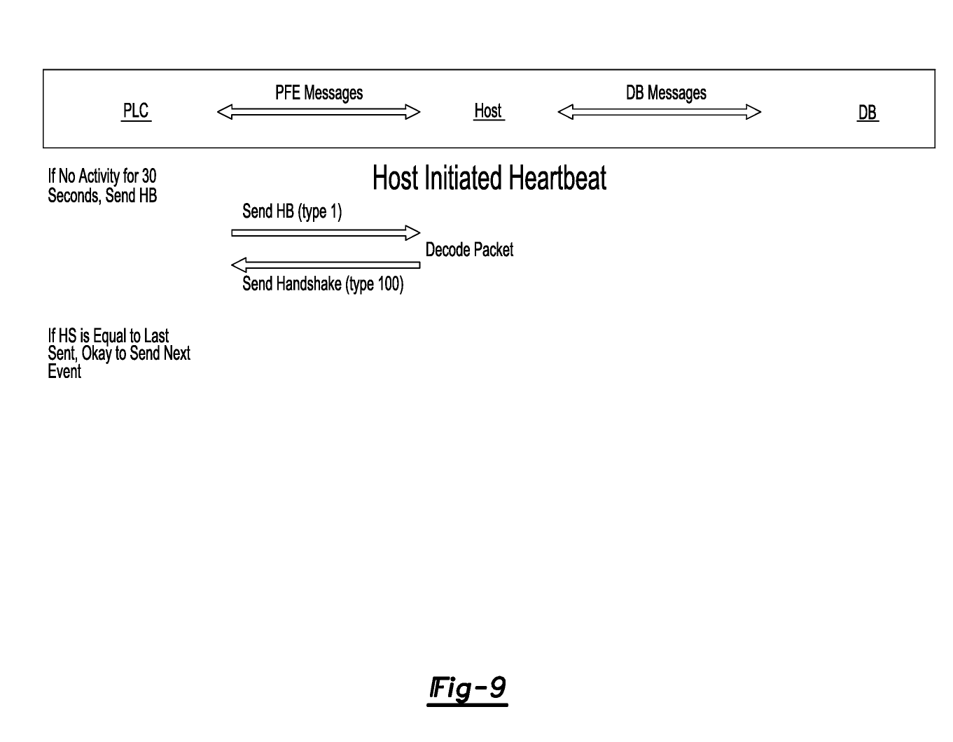

Referring to FIG. 9, another representative PFE message is the host-initiated electronic heartbeat (HB) PFE message described above with reference to FIG. 3. In this PFE message, the host 16 can verify the status of devices that have not communicated with the host 16 within a predetermined duration. Having not received communications from the PLC 14 or other device within the predetermined duration, such as within 30 seconds in the example shown in FIG. 9, the host 16 requests and receives an electronic heartbeat (HB) from the PLC 14, which can also be configured to automatically generate the electronic heartbeat (HB) upon the passage of the predetermined duration. The host 16 decodes the packet representing the PFE message, and sends an electronic handshake (HS) in return. The PLC 14 is then free to send the next event.

In accordance with the invention as set forth hereinabove, the system 10 of FIG. 1 and the method 100 of FIG. 5 manage plant floor information by enabling a single point of configuration that is self-configurable. The system 10 and method 100 are event-based, with the PFE message being encoded as a particular bit array as defined by the common definition file/schema, which is pushed upward from a particular process or line, that is from a particular PLC 14 (see FIGS. 1 and 2), to a system database such as the database 18 and the host 16 of FIGS. 1 and 2, and/or to any other servers, appliances, or process devices as desired. New messages communicated via the display devices 20, 20A, and/or 20B (see FIG. 2) may be flexible rather than fixed in length per the existing standard, with only changed information being transmitted as a PFE message, and only when a change occurs unless otherwise desired, rather than transferring all information on a polled basis. A controls engineer or other operator can change the information or PFE message being reported from a particular line, process, or subprocess at a single PLC 14 (see FIGS. 1 and 2), without having to hard-code the database 18 or the host 16 (see FIGS. 1 and 2), as any changes are automatically mapped upward from the PLC 14 upon entry. In this manner, the system 10 (see FIG. 1) and method 100 (see FIG. 5) provide a single point of configuration that is self-configurable, self-describing, and ultimately self-maintainable.

While the best mode for carrying out the invention has been described in detail, those familiar with the art to which this invention relates will recognize various alternative designs and embodiments for practicing the invention within the scope of the appended claims.

1. A method for managing information on a plant floor, the method comprising:
recording a schema in a first memory location of a source device;
generating a first plant floor event (PFE) message corresponding to at least one of an internal process variable and an external input variable, wherein the first PFE message is a set of information having a structure defined by the schema;
automatically transferring the first PFE message from the source device to a second memory location of a host device when at least one value of the first PFE message changes from a known value; and
executing at least one action in response to the first PFE message.

2. The method of claim 1, wherein executing at least one action includes at least one of transmitting a second PFE message from the host device to the source device and activating an alarm.

3. The method of claim 2, wherein at least one of the first PFE message and the second PFE message is selected from the group consisting of a production count, an alarm status, a process status, a progress indicator, a device configuration status, and a reconfiguration command.

4. The method of claim 1, wherein the source device is configured as a first programmable logic controller (PLC) having a human-machine interface (HMI).

5. The method of claim 1, further comprising determining whether the schema is a known schema stored within the host device; and
automatically recording the schema within the host device when the schema is not among the known schema.

6. The method of claim 1, wherein recording the schema includes recording an extended markup language (XML) schema.

7. The method of claim 1, wherein generating a first PFE message includes encoding the set of information as one of a bit array and a string array.

8. The method of claim 1, wherein the host device is selected from the group consisting of a server, a data acquisition (DAQ) system, an information database, a PLC device, and a display device.

9. The method of claim 1, wherein generating the first PFE message includes assigning a code uniquely identifying an event type of the first PFE message.

10. The method of claim 9, wherein the event type is selected from the group consisting of an electronic handshake, an electronic heartbeat, an IP address, a reset event, a time synchronization event, a resource event, an alarm event, a counter event, a record event, a schema event, and an ad-hoc event.

11. The method of claim 1, wherein executing at least one includes altering a configuration of at least one of the source device and the host device.

12. A method for managing information on a plant floor using a plurality of computing devices, the method comprising:
recording an extended markup language (XML) schema in a first one of the plurality of computing devices;
encoding a plurality of different information pieces as one of a bit array and a string array having a structure defining a first plant floor event (PFE) message, the first PFE message having a structure defined by the XML schema;
automatically transferring the information pieces from the first computing device to a second one of the plurality of computing devices without hardcoding the second computing device, to thereby render the method self-configuring;
automatically transferring the XML schema from the first computing device to the second computing device when the XML schema is an unknown schema without providing a pre-established fixed packet structure in the second computing system, to thereby render the method self-describing; and
executing at least one action in response to the first PFE message.

13. The method of claim 12, wherein executing at least one action includes at least one of transmitting a second PFE message from the second computing device to the first computing device and activating an alarm.

14. The method of claim 13, wherein each the first and second computing devices is selected from the group consisting of a programmable logic controller (PLC), a portable digital assistant (PDA), a human-machine interface (HMI), a database, an electronic appliance, and a Turing machine.

15. The method of claim 14, further comprising:
defining an unknown PFE message in the first computing device, the unknown PFE message being one of a new PFE message and a modified PFE message; and
automatically mapping the unknown PFE message from the first computing device to a second memory location of the second computing device and to a third memory location of a third computing device in response to the unknown PFE message.

16. The method of claim 14, wherein executing at least one action in response to the first PFE message includes at least one of recording an alarm in an alarm database and transmitting a message between the second computing device and the first computing device.

17. The method of claim 14, wherein executing at least one action in response to the PFE message includes activating a display device.

18. An information management system for use on a plant floor, the system comprising:
a programmable logic controller (PLC) having a definition file for defining a data structure for a plant floor event (PFE) message, the PLC being configured for generating the PFE message in response to at least one of an internal process variable and an external input variable;
an alarm database in electrical communication with the PLC, the alarm database being configured for storing a plurality of different alarm codes; and
a host device in electrical communication with the PLC;
wherein the system is self-configurable by being adapted for automatically propagating the PFE message from the PLC to the host device, and is self-defining by being adapted for automatically propagating a change in the definition file to the host device; and
wherein the system is configured for executing at least one action in response to the PFE message.

19. The system of claim 18, wherein the host device is selected from the group consisting of another PLC, a server, data acquisition system, a storage device, and a display device.

20. The system of claim 18, wherein the at least one action is selected from the group consisting transmitting a second PFE message from the host device to the PLC device and activating an alarm.
